(19) United States
(12) Patent Application Publication
(10) Pub. No.: US 2020/0009015 A1
(43) Pub. Date: Jan. 9, 2020

(54) STORAGE BOX FOR CONTAINING INJECTION-SOLUTION CONTAINER AND SYSTEM FOR PICKING THE INJECTION-SOLUTION CONTAINER

(71) Applicant: OOKUMA ELECTRONIC CO.,LTD., Kumamoto (JP)

(72) Inventors: Keiji OKUMA, Kumamoto (JP); Yuji MORITA, Kumamoto (JP); Masayoshi NISHIBUE, Kumamoto (JP)

(21) Appl. No.: 16/572,039

(22) Filed: Sep. 16, 2019

Related U.S. Application Data
(63) Continuation of application No. PCT/JP2018/009359, filed on Mar. 10, 2018.

(30) Foreign Application Priority Data
Mar. 22, 2017 (JP) 2017-056207

(51) Int. Cl. A61J 1/16; B65D 25/10; B65G 47/90

(52) U.S. Cl. CPC A61J 1/16; G05B 2219/50391; B65G 47/90; B65D 25/108

(57) ABSTRACT

Provided is a storage box for containing therein a columnar hollow injection-solution container. The storage box includes a case opening at a top end thereof, and a mounting section provided in the vicinity of a lower end of the case, and designed to mount the injection-solution container thereon. The mounting section includes protrusion rows. Each of the protrusion rows includes a plurality of protrusions each upwardly extending or expanding from an upper surface of the mounting section in a predetermined direction. Phases of the protrusions are alternately arranged in the predetermined direction within the adjacent protrusion rows. The mounting section further includes a wavy section at the upper surface thereof. The wavy section includes mountain parts and valley parts alternately positioned in the predetermined direction. The protrusion rows are arranged along summits of the mountain parts. According to the storage box, the injection-solution container thrown in any posture into the case is caused to take a laid-down posture.

### CROSS-REFERENCE TO RELATED APPLICATIONS

This application is a continuation application of PCT Application No. PCT/JP2018/009359, filed on Mar. 10, 2018, which claims priority to Japanese Patent Application No. 2017-056207, filed on Mar. 22, 2017, the entire contents of which are incorporated by reference in its entirety.

### FIELD OF THE INVENTION

The present invention relates to a storage box to be used for containing an injection-solution container having been provided to a medical site from a pharmacy section of a hospital, and in particular to a storage box to be used for containing an injection-solution container, suitable when the injection-solution containers having been stored in the storage box are picked one by one in accordance with image data obtained by imaging the injection-solution containers, and further to a system for picking injection-solution containers, including the above-mentioned storage box.

In a medical site such as a hospital, injection-solution containers such as a syringe, an ampule body, and a vial, having been used to become empty, were conventionally disposed after implementing necessary safety process. Alternatively, an injection-solution container, once provided to a medical site, may be kept unopened (hereinafter, referred to as “a non-used injection-solution container”) because of change in patient's condition. The non-used injection-solution container is collected and returned back to a pharmacy section, for instance. It is important to grasp medical fee points of these injection-solution containers, regardless of whether they have already been used or not, in terms of medical cost management in medical organizations and/or requesting a patient payment of drug cost.

Thus, in a medical site, the injection-solution containers are counted to aggregate medical fee points. This counting process involves complicated and difficult manual tasks. Specifically, injection-solution containers with various shapes are picked up one by one to read, with eyes, data provided in a label attached to an outer surface of each of injection-solution containers so as to count the read data. Thus, a mistake in the counting due to misreading of data sometimes takes place.

In order to solve the problem as mentioned above, there has been developed a technique for automating a series of process of taking injection-solution containers out of a storage box and reading data of a label attached to the injection-solution containers. As an example, a patent document 1 has suggested a storage box for containing injection-solution containers, and a picking system.

### PRIOR ART DOCUMENTS

### Patent Documents

Patent document 1: Japanese Patent Application Publication No. 2014-8997

Patent document 2: Japanese Patent Application Publication No. 2010-115339

### DISCLOSURE OF THE INVENTION

### Problems to be Solved by the Invention

As is taught in the patent document 1, in identifying a sort of or a content of an injection-solution container in such a picking system, it is considered advantageous if an image of an injection-solution container having been thrown into a storage box is obtained by means of a camera located above the storage box and is processed to obtain information on an appearance of an injection-solution container and/or a label stuck on an outer surface of an injection-solution container.

Furthermore, in order to efficiently and accurately image external features of an injection-solution container and/or a label stuck on an outer surface of an injection-solution container by means of a camera located above the injection-solution container, it is considered advantageous if an injection-solution container is kept unmoved not in a standing posture, but in a laid-down posture in a storage box.

Accordingly, the storage box for containing therein injection-solution containers, disclosed in the patent document 1, is designed to include a case opened at a top end thereof, and a wavy mounting section formed at the case for mounting thereon injection-solution containers. The wavy mounting section has a wavy surface comprised of a plurality of alternately arranged projections and recesses. The wavy mounting section is designed to cause an injection-solution container having been thrown into a storage box in a certain posture, to take a laid-down posture by means thereof.

That is, the storage box for containing injection-solution containers therein, disclosed in the patent document 1, provides an advantage that even if an injection-solution container, having been thrown into the storage box in a certain posture, is going to be kept in a standing posture at a bottom surface of the wavy mounting section by being supported on the wavy mounting section, the injection-solution container is not able to maintain its balance and is caused to be in a laid-down posture due to a wavy surface of the mounting section on which an injection-solution container is to stand through a bottom surface thereof.

However, the above-mentioned advantage can be ensured only in the case that an injection-solution container is relatively thin, specifically, an outer diameter of a bottom surface of an injection-solution container is smaller than an interval between adjacent projections. If an outer diameter of a bottom surface of an injection-solution container is greater than an interval between adjacent projections, the injection-solution container is kept in an upright standing posture, because the injection-solution container is supported at a bottom surface thereof across the adjacent projections, resulting in a problem that requisite data on the injection-solution container cannot be obtained by a camera.

In view of the above-mentioned problems in the prior art, it is an object of the present invention to provide a storage box for containing therein injection-solution containers, capable of ensuring that an injection-solution container having been thrown thereinto in a certain posture is surely caused to be in a laid-down posture by a mounting section of the storage box, regardless of an outer diameter of a bottom surface of an injection-solution container, and accordingly, assisting a camera to image external features of an injection-solution container and/or data of a label stuck onto an outer surface of an injection-solution container. It is further an object of the present invention to provide a system for picking an injection-solution container.

### Solution to the Problems

In a first aspect, there is provided a storage box for containing therein a columnar hollow injection-solution container, the storage box including a case opening at a top end thereof, and a mounting section provided in the vicinity of a lower end of the case and designed to mount the injection-solution container thereon, the mounting section including protrusion rows, each of the protrusion rows including a plurality of protrusions each upwardly extending or expanding from an upper surface of the mounting section in a predetermined direction, phases of the protrusions being alternately arranged in the predetermined direction within the adjacent protrusion rows, wherein the injection-solution container thrown in any posture into the case is caused to take a laid-down posture.

In a second aspect, there is provided the storage box according to the first aspect, wherein the mounting section includes a wavy section at the upper surface thereof, the wavy section including mountain parts and valley parts alternately positioned in the predetermined direction, the protrusion rows being arranged along summits of the mountain parts.

In a third aspect, there is provided the storage box according to the second aspect, wherein each of the protrusions is shaped to be wavy or mountain-like when viewed in a direction perpendicular to the predetermined direction.

In a fourth aspect, there is provided the storage box according to the second aspect, wherein taller and shorter projections are alternately arranged along the summits, the taller projections defining the protrusions.

In a fifth aspect, there is provided the storage box as set forth according to any one of the second to fourth aspects, wherein the case is open at a lower end thereof, the mounting section being slidable in the predetermined direction to open and close the open lower end of the case.

In a sixth aspect, there is provided the storage box according to the fifth aspect, wherein the case includes extending lower ends fittable into the valley parts, the mounting section sliding with the valley parts being almost fit into the extending lower ends.

In a seventh aspect, there is provided the storage box according to the sixth aspect, further including slope sections extending along the summits, the slope sections each having a falling gradient from each of the taller projections towards each of the shorter projections located adjacent thereto.

In an eighth aspect, there is provided the storage box according to the seventh aspect, wherein each of the projections facing each other along the summits has an obliquely chamfered portion at a side thereof.

In a ninth aspect, there is provided the storage box as set forth in any one of the second to eighth aspects, wherein each of the protrusions is formed at upper ends thereof or each of the summits is partially formed with an auxiliary groove downwardly recessing.

In a tenth aspect, there is provided the storage box according to the third aspect, wherein each of the protrusion row is shaped to be a range of mountains comprising a plurality of mountains positioning in the predetermined direction, when viewed in a direction perpendicular to the predetermined direction.

In an eleventh aspect, there is provided a system for picking a columnar hollow container in which an injection solution is contained, the system comprising a storage box according to any one of the first to tenth aspects, an imaging section for taking an image of the injection-solution container having been caused to a laid-down posture, from above the storage box, an image processing section for processing image data taken by the imaging section, a robot hand picking the injection-solution containers one by one, and a control section for controlling operation of the robot hand.

In a twelfth aspect, there is provided the system according to the eleventh aspect, further including vibration means for vibrating the storage box or the mounting section.

### Advantages Provided by the Invention

The storage box for containing therein a columnar hollow injection solution container, in accordance with the present invention, is designed to include a case opening at a top end thereof, and a mounting section provided in the vicinity of a lower end of the case and designed to mount the injection-solution container thereon, the mounting section including protrusion rows, each of the protrusion rows including a plurality of protrusions each upwardly extending or expanding from an upper surface of the mounting section in a predetermined direction, phases of the protrusions being alternately arranged in the predetermined direction within the adjacent protrusion rows, wherein the injection-solution container thrown in any posture into the case is caused to take a laid-down posture.

Thus, it is possible to set an interval between a protrusion in a protrusion row and a protrusion in an adjacent protrusion row to be greater than an outer diameter of a bottom surface of an injection-solution container by adjusting a phase in protrusion arrangement between adjacent protrusion rows. Accordingly, even if a relatively thick injection-solution container with a bottom surface having an outer diameter greater than an interval between adjacent protrusion rows is to straddle adjacent protrusion rows, the injection-solution container cannot keep straddling the adjacent protrusion rows, and thus cannot be prevented from inclining. Thus, the injection-solution container finally loses its balance to be in a laid-down posture. As a result, it is possible to provide a storage box for containing therein injection-solution containers, which is suitable for taking images of the storage box with the injection-solution containers stored therein from the top, followed by picking the injection-solution containers one by one in accordance with the images.

Furthermore, the mounting section is designed to include a wavy section at the upper surface thereof, the wavy section including mountain parts and valley parts alternately positioned in the predetermined direction, the protrusion rows being arranged along summits of the mountain parts. Thus, even if a relatively thin injection-solution container having a bottom with an outer diameter smaller than an interval between adjacent protrusions, is thrown into a storage box such that the injection-solution container stands upright between adjacent protrusions, the injection-solution container loses its balance to be led to a laid-down posture by geometric function provided by the inclination of the wavy section or summits of the mountain parts. In addition, an injection-solution container in a laid-down posture tends to finally hold still in a most stable direction with an axis thereof being along the valley parts of the wavy section, which facilitates picking of the container.

Furthermore, each of the protrusions is designed to be in a wavy or mountain-like shape when viewed in a direction perpendicular to the predetermined direction. Thus, even if an injection-solution container is laid down in a direction perpendicular to the predetermined direction when viewed vertically, there is generated a moment that rotates the injection-solution container in a clockwise or counter-clockwise direction when viewed vertically by virtue of functions of slopes of the protrusions arranged in a wavy or mountain-like shape. Accordingly, the injection-solution container tends to finally hold still in the most stable posture in which an axis of the container extends along the valley parts of the wavy section.

Furthermore, taller and shorter projections are alternately arranged along the summits, and the taller projections defines the protrusions. Thus, merely by selecting heights of the taller and shorter projections in accordance with a shape of a target injection-solution container, it is possible to accomplish the feature, which is a necessary geometric condition, that the mounting section includes protrusion rows, each of the protrusion rows including a plurality of protrusions each upwardly extending or expanding from an upper surface of the mounting section in a predetermined direction, phases of the protrusions being alternately arranged in the predetermined direction within the adjacent protrusion rows. Consequently, the mounting section can be readily designed.

The case is open at a lower end thereof, and the mounting section is slidable in the predetermined direction to open and close the open lower end of the case. Thus, by a simple operation of sliding the mounting section in a predetermined direction, it is possible to remove injection-solution containers having not been picked and remaining on the mounting section, out of the storage box.

The case includes extending lower ends fittable into the valley parts, and the mounting section sliding with the valley parts is almost fit into the extending lower ends. Thus, in sliding of the mounting section in the predetermined direction, wastes such as ampule caps having remained on the valley parts of the mounting section are caused to automatically drop off through the open end in abutting the extending lower ends, and are removed out of the storage box.

Furthermore, the storage box is designed to further include slope sections extending along the summits, the slope sections each having a falling gradient from each of the taller projections towards each of the shorter projections located adjacent thereto. Thus, even if an injection-solution container is laid down in a direction perpendicular to the predetermined direction when viewed vertically, the container is able to readily slide down with a body thereof on the downslope slope sections. This generates a moment that rotates the injection-solution container when viewed vertically. The injection-solution container therefore tends to finally hold still in a stable direction with an axis thereof being along the valley parts of the wavy section. Furthermore, in the case that an injection-solution container is formed at an end thereof with a flange, it may be difficult to slide the mounting section because the flange is sandwiched between a taller projection and an extending lower end. However, in sliding of the mounting section, the flange is upwardly and smoothly guided by the upslope slope section extending from a shorter projection towards a taller projection, and thus, the flange can readily climb over a taller projection. Accordingly, it is possible to prevent the difficulty of sliding of the mounting section.

Each of the projections facing each other along the summits is designed to have an obliquely chamfered portion at a side thereof. Thus, even if the flange of an injection-solution container enters a space formed between a projection and an extending lower end in sliding of the mounting section, the flange can readily climb over a projection by being upwardly and smoothly guided by means of the chamfered portion. Consequently, it is possible to prevent the difficulty in sliding of the mounting section due to the flange sandwiched between a side of a projection and an extending lower end.

Each of the protrusions is designed to be formed at upper ends thereof with an auxiliary groove downwardly recessing, or each of the summits is partially formed with an auxiliary groove downwardly recessing. Thus, in using a suction pad provided at an end of a picking robot hand for suction and hold of a target by virtue of negative pressure, it is possible to prevent unexpected circumstances in which the suction pad sucks an upper end of a projection and/or a part of a summit to bar proper operation of a robot hand. This is prevented by the auxiliary groove to permit the partial suction air to escape therethrough. Thus, the picking process can be smoothly accomplished as scheduled.

Each of the protrusion row is shaped to be a range of mountains comprising a plurality of mountains positioning in the predetermined direction when viewed in a direction perpendicular to the predetermined direction. Thus, even if an injection-solution container is laid down in a direction perpendicular to the predetermined direction when viewed vertically, the container is able to slide at a body thereof along a skirt of the mountains. Thus, there is generated a moment that rotates the injection-solution container when viewed vertically. Accordingly, the injection-solution container tends to finally hold still in a stable direction with an axis thereof being along the valley parts of the wavy section. Furthermore, since the mounting section has a simply shaped upper surface, the mounting section can be readily manufactured by injection molding of synthetic resin, for instance.

The present invention further provides a system for picking a columnar hollow container in which an injection solution is contained, the system including a storage box according to any one of the first to tenth aspects, an imaging section for taking an image of the injection-solution container having been caused to be in a laid-down posture, from above the storage box, an image processing section for processing image data taken by the imaging section, a robot hand picking the injection-solution containers one by one, and a control section for controlling operation of the robot hand. Since the imaging section can take an image of an injection-solution container having been stored in a laid-down posture in the storage box, the image processing section is able to readily and surely analyze and grasp characters and histories of an injection-solution container. This enhances picking accuracy in the picking system.

The picking system further includes a vibration device for vibrating the storage box or the mounting section. Thus, even if some of injection-solution containers, for some reasons, are not led to a laid-down posture merely by being thrown into the storage box, the vibration generated by the vibration device and applied to the injection-solution containers or the mounting section surely causes the injection-solution containers to be in a laid-down posture. This further enhances picking accuracy in the picking system.

### BRIEF DESCRIPTION OF THE DRAWINGS

FIG. 1 illustrates an example of an injection-solution container in an embodiment of the present invention, in which FIGS. 1A and 1B illustrate a vial, FIG. 1C illustrates an ampule body, and FIG. 1D illustrates a syringe.

FIG. 2 illustrates an example of waste in an embodiment of the present invention, in which FIG. 2A illustrates an ampule head, FIG. 2B illustrates a vial cap, and FIG. 2C illustrates a glass piece.

FIG. 3 is a perspective view of a storage box for containing therein an injection-solution container in accordance with a first embodiment of the present invention, in which FIG. 3A illustrates a condition in which a mounting section is stored in a case, and FIG. 3B illustrates a condition in which more than a half of the mounting section is drawn out of the case.

FIG. 4 is a plan view of a storage box for containing therein an injection-solution container in accordance with the first embodiment of the present invention, in which FIG. 4A is a plan view corresponding to FIG. 3A, and FIG. 4B is a plan view almost corresponding to FIG. 3B.

FIG. 5 is a front view of a storage box for containing therein an injection-solution container, in accordance with the first embodiment of the present invention.

FIG. 6 is a cross-sectional view taken along a line K-K shown in FIG. 4A.

FIG. 7 is a perspective view of a mounting section in a storage box for containing therein an injection-solution container, in accordance with the first embodiment of the present invention.

FIG. 8 shows the function of a storage box for containing therein an injection-solution container, in accordance with the first embodiment of the present invention, in which FIGS. 8A to 8D illustrate the behavior of a vial having a bottom with a small outer diameter, having been thrown into the mounting section in the storage box.

FIG. 9 shows another function of a storage box for containing therein an injection-solution container, in accordance with the first embodiment of the present invention, in which FIGS. 9A to 9D illustrate the behavior of a vial having a bottom with a great outer diameter, having been thrown into the mounting section in the storage box.

FIG. 10 illustrates a system for picking an injection-solution container, in accordance with the first embodiment of the present invention.

FIG. 11 is a perspective view of a mounting section in a storage box for containing therein an injection-solution container, in accordance with a second embodiment of the present invention.

FIG. 12 shows the function of a storage box for containing therein an injection-solution container, in accordance with the second embodiment of the present invention, in which FIGS. 12A to 12C illustrate the behavior of the injection-solution container lie down on the mounting section in the storage box.

FIG. 13 shows another function of a storage box for containing therein an injection-solution container, in accordance with the second embodiment of the present invention.

FIG. 14 is a perspective view of a mounting section in a storage box for containing therein an injection-solution container, in accordance with a third embodiment of the present invention.

FIG. 15 is a partially enlarged view of a mounting section in a storage box for containing therein an injection-solution container, in accordance with the third embodiment of the present invention.

FIG. 16 is a cross-sectional view taken along a line M-M shown in FIG. 14.

### EMBODIMENTS FOR REDUCING THE INVENTION TO PRACTICE

Hereinbelow are explained embodiments in accordance with the present invention with reference to the drawings.

The present invention relates to a storage box into which a plurality of columnar hollow injection-solution containers such as an ampule body, having been used in a medical site such as an operation room, is randomly thrown. The storage box for containing therein injection-solution containers, in accordance with embodiments of the present invention, is equipped in a later-mentioned system for picking an injection-solution container, which is suitable for picking injection-solution containers one by one, and makes it easy to remove wastes such as ampule caps.

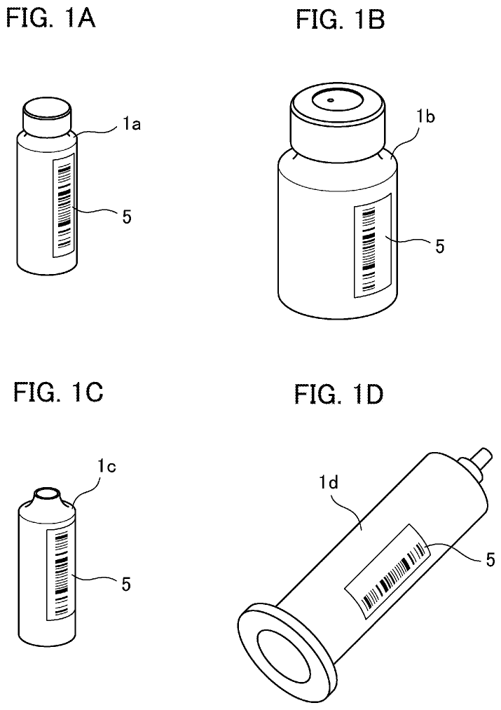

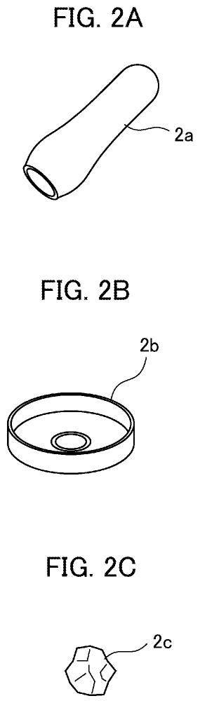

Before explaining the storage box in accordance with the embodiments of the present invention, articles to be stored in a storage box 10 are explained with reference to FIGS. 1 and 2.

As illustrated in FIGS. 1 and 2, the above-mentioned articles include wastes such as a columnar hollow container 1 for containing therein injection solution, an ampule head 2a cut from a body, a vial cap 2b released out of a head of a vial, and a glass piece 2c, and so on.

Specifically, the columnar hollow injection-solution container 1 indicates a vial 1a, 1b illustrated in FIGS. 1A and 1B, an ampule body 1c illustrated in FIG. 1C, or a syringe 1d illustrated in FIG. 1D. The vial 1a has an outer diameter smaller than the same of the vial 1b.

A shape of the above-mentioned injection-solution container is not to be limited to a cylinder, but includes various types such as a hexagonal cylinder having a substantially hexagonal cross-section, or a column having a rectangular cross-section close to a substantial ellipse. Furthermore, the injection-solution container 1 includes an empty one out of which injection solution already has been used, a container containing therein some amount of injection solution, and an unopened one such as a non-used injection-solution container mentioned above.

As illustrated in FIGS. 1A to 1D, a bar code 5 indicating identification data of an injection-solution container, such as a name of injection solution and a price thereof, is stuck onto a sidewall of the injection-solution container 1.

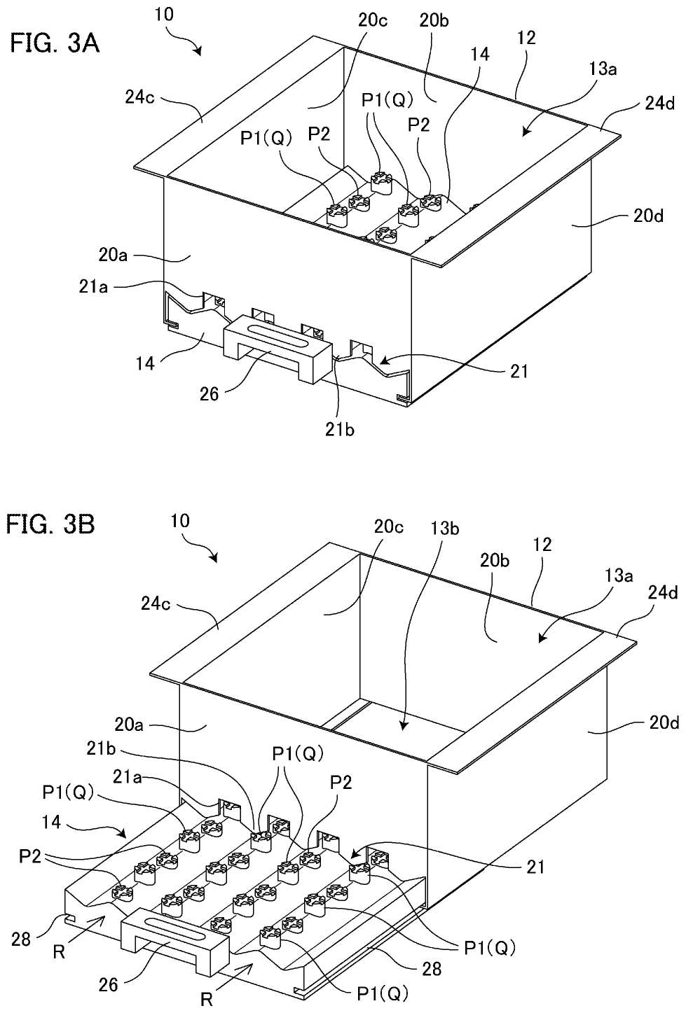

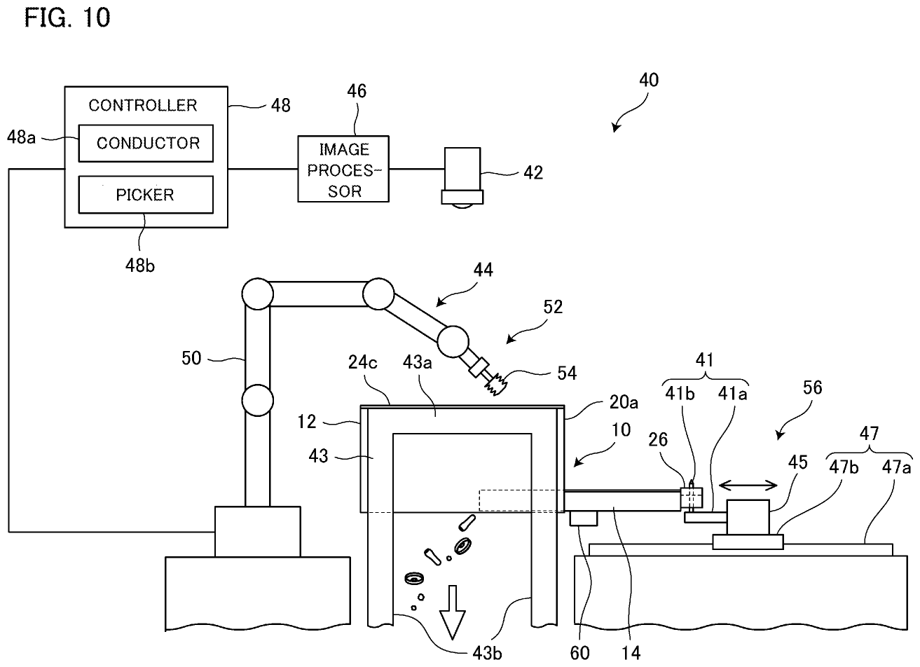

After having been stored into the storage box 10 exemplarily illustrated in FIG. 3, the injection-solution containers 1 are taken out one by one by means of a system 40 for picking an injection-solution container, exemplarily illustrated in FIG. 10, and then, are set in a data reading apparatus (see the patent document 2, for instance) having a function of reading a bar code. Thus, data is read from the bar code, and the thus read data is used for calculation of medical fee, cost management or medicine management.

### First Embodiment

A storage box for containing therein injection-solution containers, in accordance with a first embodiment of the present invention, is explained hereinbelow with reference to FIGS. 3 to 10.

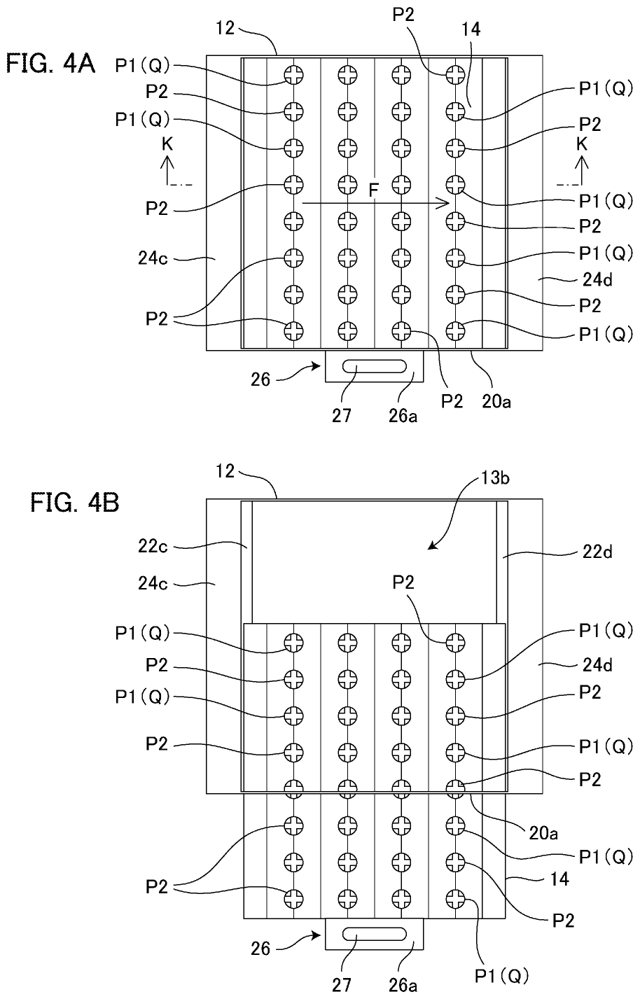

As illustrated in FIG. 3, the storage box 10 in accordance with the first embodiment includes a columnar case 12 being open at upper and lower ends thereof, and a mounting section 14 on which the injection-solution containers 1 are mounted. FIG. 3A illustrates a condition in which the mounting section 14 is stored in the case 12 to thereby close an opening 13b formed at the lower end of the case 12, and FIG. 3B illustrates a condition in which more than a half of the mounting section 14 is drawn out of the case 12. FIG. 4A is a plan view corresponding to FIG. 3A, and FIG. 4B is a plan view almost corresponding to FIG. 3B.

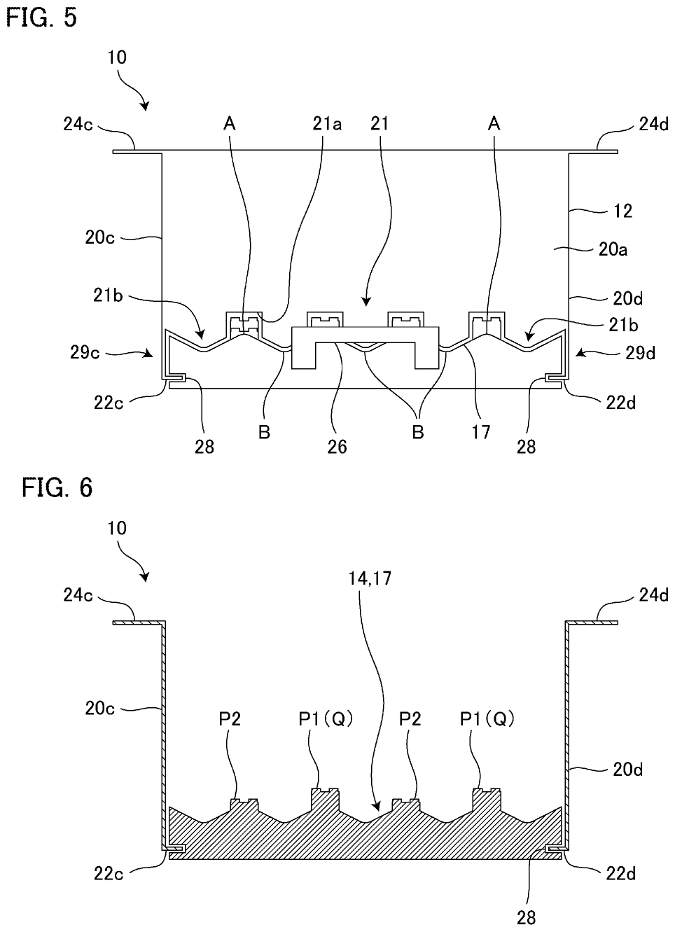

As illustrated in FIGS. 3 and 4, the case 12 is defined as a hollow rectangular parallelepiped case having an opening 13a at the upper end and the opening 13b at the lower end. Specifically, as illustrated in FIGS. 3 and 5, the case 12 includes a front vertical plate 20a, a rear vertical plate 20b, a left-side vertical plate 20c, and a right-side vertical plate 20d. Furthermore, as illustrated in FIGS. 5 and 6, the left-side vertical plate 20c and the right-side vertical plate 20d are formed at lower ends 29c and 29d, respectively, with extending plates 22c and 22d, respectively, each horizontally extending by a short length towards the inside of the case 12. The extending plates 22c and 22d are mentioned later.

As illustrated in FIGS. 3, 4 and 5, the case 12 includes engagement plates 24c and 24d each horizontally extending by a short length externally towards left and right of the case 12 from upper ends of the left-side vertical plate 20c and the right-side vertical plate 20d, respectively. These engagement plates 24c and 24d are engaged to a later-mentioned frame 43 to make it possible to support the case 12 on the frame 43.

As illustrated in FIGS. 3 and 5, the case 12 includes extending lower ends 21b. The extending lower ends 21b are defined by a downwardly extending part of a lower end 21 of the front vertical plate 20a. The extending lower ends 21b are mentioned later.

The injection-solution containers 1a, 1b and 1c are randomly thrown in a certain posture into the case 12 through the opening 13a extensive at the upper end of the case 12. Wastes such as the ampule head 2a, vial cap 2b and glass piece 2c are also thrown into the case 12 together with the injection-solution containers.

The case 12 is not to be limited to a rectangular parallelepiped case shown in the first embodiment. For instance, the case 12 may be formed as a cylinder or an ellipse cylinder each being open at an upper end thereof.

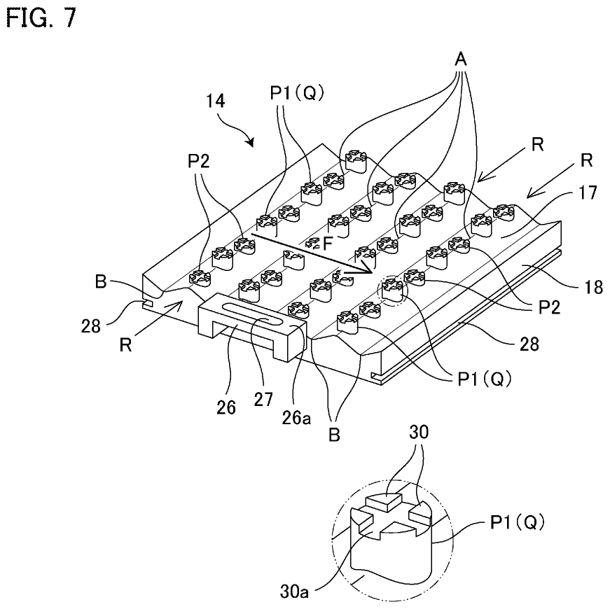

As illustrated in FIGS. 4 and 7, the mounting section 14, which is an essential element in the first embodiment, includes a main body 18 comprised of a plate having almost the same size as that of a bottom of the case when viewed vertically, and a handle 26 located at a front of the main body 18.

As illustrated in FIG. 7, the main body 18 is formed at an upper surface thereof with a wavy section 17 including mountain parts A and valley parts B alternately arranged in a direction F in which waves go on. As illustrated in FIGS. 3 and 7, both the mountain parts A and the valley parts B linearly extend in a predetermined direction perpendicular to the wave-going direction F. As illustrated in FIGS. 5, 6 and 8, the mountain parts A are designed to have a summit (an upper end) equal in height to one another.

As illustrated in FIGS. 3 and 7, each of the mountain parts A is designed to have a plurality of projections P along the summit thereof. The projections P are equally spaced away from another. The mountain part A and the projections P are formed integral with each other. Each of the projections P is shaped as an upwardly extending cylinder. The projections P are comprised of two groups of projections having different heights from each other, that is, taller projections P1 and shorter projections P2. In each of the mountain parts A, it is understood that the taller and shorter projections P1 and P2 are alternately arranged along a summit, and that the taller and shorter projections P1 and P2 are arranged oppositely to each other, comparing the adjacent mountain parts A with each other. Specifically, as illustrated in FIG. 7, in the mountain parts A situated at the first and third rows from the left end of the mounting section 14, the taller and shorter projections P1 and P2 are aligned in a sequence of (P2, P1, P2, P1, - - - ) from the front. Also, in the mountain parts A situated at the second and fourth rows, the taller and shorter projections P1 and P2 are aligned in a sequence of (P1, P2, P1, P2, - - - ) from the front.

Here, only the taller projections P1 are referred to as “protrusions Q” which upwardly extend or expand from an upper surface of the mounting section 14. The mounting section 14 includes protrusion rows R comprised of a plurality of protrusions Q aligned in the predetermined direction. Furthermore, it is understood that, comparing the protrusion rows R located adjacent to each other, phases for aligning the protrusions Q deviate from each other in the predetermined direction, that is, phases for aligning the protrusions Q (the projections P1) in the adjacent protrusion rows R are opposite to each other.

Furthermore, as illustrated in FIG. 7, the substantially cylindrical projections P1 and P2 are designed to have a substantially horizontal flat surface 30 at the upper ends thereof. The surface 30 is formed with an auxiliary groove 30a recessed downwardly. The auxiliary groove 30a is cross-shaped when viewed vertically. The function of the auxiliary groove 30a is explained later.

Though upper ends of the mountain parts A and lower ends of the valley parts B in the first embodiment are illustrated to be arcuate in FIGS. 5, 6, 7 and 8, cross-sectional shapes of them are not to be limited to an arcuate shape, but may be triangular, for instance. However, if they are designed to be triangular, it is afraid that, in images taken by the imaging section in the picking system mentioned later, linear images along the summits may appear in the firstly mentioned images due to a difference in light reflection between a summit of a triangle and a slope of a triangle. Since such linear images make noises irrelevant of images of the injection-solution containers 1, they may be removed in an image-processing step.

On the other hand, in the case that the mountain parts and the valley parts are designed to have a substantially arcuate cross-section, portions located in the vicinity of summits of the mountain parts and bottoms of the valley parts are smoother than being triangular, and accordingly, a difference in light reflection between summits of the mountain parts (or the valley parts) and slopes of the mountain parts (or the valley parts is reduced. Thus, it is possible to prevent the linear images extending along the summits (or bottoms) from appearing in the above-mentioned images.

As illustrated in FIGS. 4 and 7, the handle 26 is designed to include a plate 26a through which a through-hole 27 is formed. The handle 26 is fixed to one of sides of the main body 18 extending in parallel with the wave-going direction F such that the handle 26 outwardly extends from the one of sides, with the plate 26a being kept substantially horizontal.

As illustrated in FIGS. 3, 5, 6 and 7, the main body 18 is formed with grooves 28, 28 at opposite ends along the wave-going direction F when viewed vertically. The grooves 28, 28 extend in a predetermined direction perpendicular to the wave-going direction F. The grooves 28, 28 are designed to have a width slightly greater than a thickness of the above-mentioned extending plates 22c and 22d.

As illustrated in FIGS. 3, 4, 5 and 6, the mounting section 14 with the above-mentioned structure is engaged to the case 12 at lower portions 29c and 29d of the case 12 by fitting the extending plates 22c and 22d into the grooves 28, 28 with the wavy section 17 being arranged to face upwards.

Herein, the above-mentioned extending lower ends 21b of the case 12 are explained. As illustrated in FIG. 5, the extending lower ends 21b in the first embodiment comprise downwardly protruding five leading portions of the front vertical plate 20a, when viewed horizontally. The extending lower ends 21b are situated slightly above the valley parts B of the wavy section 17, and are designed to be shaped to fit into the valley parts B.

Four portions of the extending lower ends 21b, upwardly recessed to correspond to the mountain parts A, are formed with substantially rectangular cut-outs 21a to allow the projections P1 and P2 standing on the summits of the mountain parts A to pass therethrough.

Accordingly, as illustrated in FIGS. 3 and 4, the mounting section 14 in the first embodiment is designed to be able to slide at the lower portions of the case 12 in the predetermined direction perpendicular to the wave-going direction F. The mounting section 14 slides to thereby open and close the lower openings 13b (open end) of the case 12. When the mounting section 14 slides, the valley parts B are fit into the extending lower ends 21b of the case 12 as illustrated in FIG. 3. Thus, in sliding of the mounting section 14 to draw out of the case 12, wastes such as the ampule heads 2a having remained on the valley parts B of the mounting section 14 are prevented from moving by the extending lower ends 21b, and hence, wastes are surely discharged downwardly through the lower opening 13b of the case 12 (see FIG. 10).

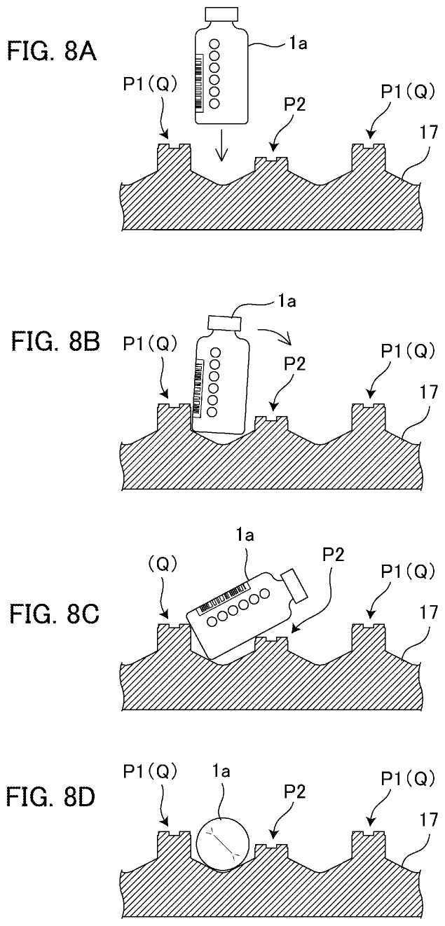

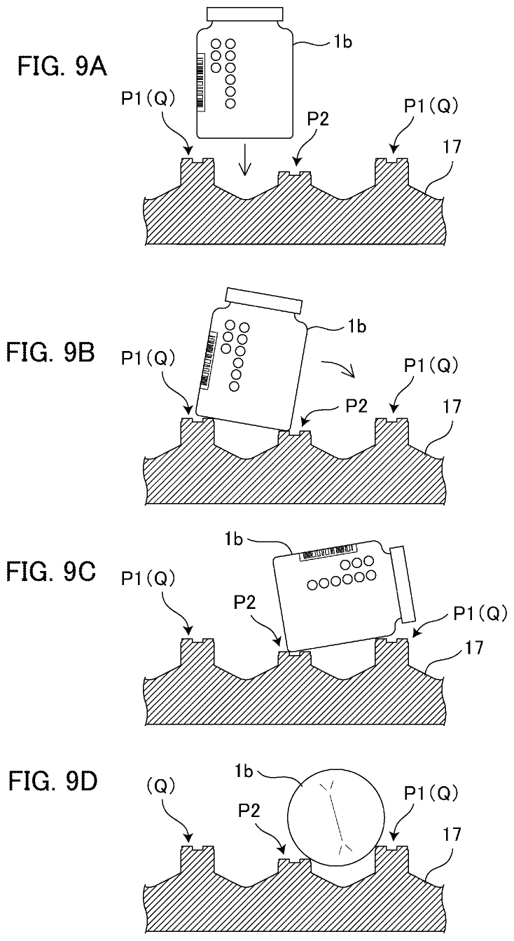

Hereinbelow is explained the function of the wavy section 17 in the first embodiment with reference to FIGS. 8 and 9.

FIGS. 8A to 8D illustrate the behavior of a vial 1a with a bottom having a small outer diameter, having been thrown into the mounting section 14 in the storage box 10, in accordance with the first embodiment. In the storage box 10 in accordance with the first embodiment, even if the vial 1a is thrown into the storage box 10 with a bottom thereof facing downwards as illustrated in FIG. 8A, the vial 1a is received at a bottom thereof by a slope of the wavy section 17 as illustrated in FIG. 8B, so that the vial 1a is in an unstable posture and tends to lie down. As illustrated in FIG. 8C, the vial 1a tends to be finally laid down. Alternatively, in the case that the vial 1a is thrown into the storage box 10 such that the vial 1a makes abutment at a bottom thereof with the projection P1(Q) or P2, the vial 1a is unstable in posture, and hence, is easy to lie down. Consequently, when the injection-solution container 1 is taken its images by means of an imaging section of a later-mentioned system for picking a injection-solution container, it is possible to obtain images suitable for image processing. This feature is explained later in detail.

FIGS. 9A to 9D illustrate the behavior of a vial 1b with a bottom having a great outer diameter, having been thrown into the mounting section 14 in the storage box 10, in accordance with the first embodiment. In the storage box 10 in accordance with the first embodiment, even if the vial 1b is thrown into the storage box 10 with a bottom thereof facing downwards and the vial 1b is going to hold still to be supported by the projections P1(Q) and P2 which the vital 1b straddles as illustrated in FIG. 9A, the vial 1b cannot stand upright and inclines due to a difference in height between the projections P1(Q) and P2, as illustrated in FIG. 9B. Thus, the vial 1b is resultingly laid down, as illustrated in FIG. 9C. In particular, the vial 1b can readily be laid down by applying vibration to the storage box 10.

As explained so far, when the mounting section 14 receives the injection-solution containers 1 having been thrown into the case 12 through the upper opening, the storage box 10 in accordance with the first embodiment causes the injection-solution containers 1 to be in a laid-down posture by means of the protrusions Q (the projections P1) and/or the wavy section 17.

In contrast, in the storage box suggested in the patent document 1, when the vial 1b with a bottom having a great outer diameter is thrown into the storage box with the bottom facing downwards and is supported by two summits of the adjacent mountain parts A so as to straddle them, the vial 1b inevitably stands upright, because the two summits have a common height. Accordingly, the vial 1b may not be in a laid-down posture.

As illustrated in FIGS. 8C and 9C, the vials 1a and 1b are caused to be in a laid-down posture along the wave-going direction F by virtue of a difference in height between the mountain parts A and the valley parts B of the wavy section 17, or a difference in height between the projections P1(Q) and P2. Thus, there is generated a moment for rotating the vials 1a and 1b when vertically viewed, and hence, the vials 1a and 1b tend to hold still at a most stable direction and position with an axis of the vials being along the valley parts B of the wavy section when vertically viewed, as illustrated in FIGS. 8D and 9D. The function as mentioned above is applied further to other injection-solution containers having different shapes.

A system 40 for picking an injection-solution container, in accordance with the current embodiment, is explained hereinbelow with reference to FIG. 10.

The container-picking system 40 includes the above-mentioned storage box 10, the frame 43 for supporting the storage box 10, an imaging section 42, a robot hand 44, an image processing section 46, a slide controller 56, and a controller 48 for controlling operation of the robot hand 44 and the slide controller 56.

As illustrated in FIG. 10, the frame 43 may be designed to include a pair of support arms 43a for supporting the engagement plates 24c and 24d of the case 12, and legs 43b each downwardly extending from front and rear ends of each of the support arms 43a, for instance. As illustrated in FIG. 10, the storage box 10 is fit into the frame 43 to thereby be supported in the frame 43 with the engagement plates 24c and 24d being mounted on upper surfaces of the support arms 43a. Thus, the storage box 10 is situated in a predetermined position.

The imaging section 42 is comprised of a conventional digital camera, for instance. As illustrated in FIG. 10, the imaging section 42 is positioned above the storage box 10, and takes images of the injection-solution containers 1 stored in the storage box 10 from the top of the storage box 10, and then, transmits image data of the injection-solution containers 1 to the image processing section 46. It should be noted that the imaging section may be comprised of a plurality of digital cameras to obtain three-dimensional image data of the injection-solution containers 1.

The image processing section 46 is comprised of a conventional image processing CPU, for instance. The image processing section 46 processes image data transmitted from the imaging section 42 to thereby recognize the injection-solution containers 1 having been imaged by the imaging section 42.

As illustrated in FIG. 10, the robot hand 44 includes a conventional arm section 50 comprised of arms indirectly coupled to one another, and a holder 52 connected to a top end of the arm section 50 for holding an injection-solution container 1.

As illustrated in FIG. 10, the holder 52 in the first embodiment is comprised of a suction-type holder. For instance, the holder 52 may be designed to include a suction pad 54 comprised of a flexible bellows, in which case, the holder 52 sucks to hold the injection-solution container 1 by virtue of a negative pressure generated at a top end of the suction pad 54 by means of a vacuum pump. It should be noted that the holder is not to be limited to a suction type used in the first embodiment, but may be designed to include a pair of claws to seize sides of the injection-solution container 1.

If the upwardly facing surface 30 of the projections P1 and P2 are wholly flat, the suction pad 54 may absorb the surface 30 during the robot hand 44 is picking the injection-solution containers 1, resulting in unexpected situation in which the robot hand 44 cannot be operated. However, as illustrated in FIG. 7, the projections P1 and P2 are formed at the surface 30 thereof with the downwardly recessed cross-shaped auxiliary groove 30a. Thus, even if the suction pad 54 makes contact with the surface 30, it is possible to prevent the suction pad 54 from sucking the surface 30. This is because a part of suction air escapes through the auxiliary groove 30a, and hence, there is not generated an intensive negative pressure at a top end of the suction pad 54. Thus, a picking process can be smoothly carried out as scheduled.

As illustrated in FIG. 10, the slide controller 56 includes a drawing arm 41, and a slider 47 for sliding the drawing arm 41.

As illustrated in FIG. 10, the drawing arm 41 includes, for instance, a bar 41a such as a cylindrical bar, and extending substantially horizontally so as to perpendicularly intersect with the front vertical plate 20a, and a pin 41b extending from an end of the bar 41a such that the pin 41b perpendicularly intersects with the bar 41a.

As illustrated in FIG. 10, the slider 47 may be comprised of a conventional linear motor, for instance. Specifically, the slider 47 may be designed to include a guide rail 47a having a stator and extending perpendicularly to the front vertical plate 20a, and a carriage 47b having a movable piece and being slidable on the guide rail 47a.

The slider is not to be limited to be comprised of a linear motor. For instance, the slider may be designed to include timing gears located in the vicinity of opposite ends the guide rail, a timing belt being tensioned across the timing gears, a servo motor for driving one of the timing gears, and a carriage slidable on the guide rail, a part of the carriage being fixed to the timing belt. As an alternative, the slider may be designed to include a rack and pinion mechanism for being slidable, for instance.

First, a driver 45 rotates the bar 41a such that the pin 41b of the drawing arm 41 faces downwards. Then, the slider 47 causes the carriage 47b to move to such a position that the pin 41b is located below the through-hole 27 of the handle 26. Then, the driver 45 rotates the bar 41a such that the pin 41b faces upwards to allow the pin 41b to be fit into the through-hole 27 of the handle 26. Thus, the handle 26 and the drawing arm 41 are engaged to each other. Thereafter, the carriage 47b is slid by the slider 47 to the right in FIG. 10, resulting in that, as illustrated in FIG. 10, the mounting section 14 is drawn out of the case 12, and hence, wastes such as ampule heads 2a having remained in the storage box 10 are moved on the mounting section 14 by means of the extending lower ends 21b of the front vertical plate 20a. Thus, wastes are removed through the opening 13b of the storage box 10.

The controller 48 is comprised of a conventional computer, for instance. The controller 48 includes a conductor 48a for conducting the robot hand 44 to a target injection-solution container 1 in accordance with data produced by the image processing section 46 by processing image data transmitted from the imaging section 42, and a picker 48b for adjusting a posture of the robot hand 44 and moving the holder 52 to thereby pick an injection-solution container. The controller 48 controls an operation of the robot hand 44. Furthermore, the controller 48 is electrically connected to the slide controller 56 for controlling operations of the slider 47 and the drawing arm 41.

The system in the first embodiment may be designed to further include means for vibrating the storage box 10. Even if some of the injection-solution containers 1 are not caused to be in a laid-down posture for some reasons merely by being thrown into the storage box 10, the vibration means vibrates the storage box 10 or the mounting section 14 to thereby ensure that the injection-solution containers are caused to be in a laid-down posture.

As illustrated in FIG. 10, the vibration means may be designed to be comprised of a small vibrator 60 attached to a lower surface of the mounting section 14, for instance. As an alternative, the mounting section 14 may be vibrated through the drawing arm 41 by vibrating the slider 47 used for drawing the mounting section 14, by small amplitude. The vibration means may be always driven in operation of the container-picking system 40. As an alternative, the controller 48 may drive the vibration means in accordance with the judgement as to a posture of the injection-solution container 1, carried out by the controller 48 based on image data transmitted from the imaging section 42. That is, the controller 48 may drive the vibration means only in the case that the controller 48 found the injection-solution containers 1 not being in a laid-down posture, or in the case that data cannot read because the bar code 5 is located underneath.

As mentioned above, the container-picking system 40 in accordance with the first embodiment makes it possible to cause the injection-solution containers 1 having been into the storage box 10, to be in a laid-down posture mainly by virtue of the geometric feature of the mounting section 14, regardless of an initial posture of the injection-solution containers 1. When the imaging section 42 located above the injection-solution containers 1 takes pictures of the injection-solution containers 1 stored in the storage box 10, it is possible to make an image size larger, and to obtain data such as geometric features of the injection-solution containers 1 in a greater amount in an image of a laid-down injection-solution container 1 than in an image of an uprightly standing injection-solution container 1. Thus, the controller 48 can swiftly, accurately and advantageously carry out a sequence of processes such as identifying injection-solution containers 1 based on image data obtained by processing images, since the injection-solution containers 1 are caused to be in a laid-down posture. Furthermore, the container-picking system 40 in accordance with the first embodiment makes it possible to readily remove wastes such as the ampule heads present in the storage box 10 merely by sliding the mounting section 14 without taking the storage box 10 out of a certain apparatus.

As having been explained so far, the first embodiment provides the storage box 10 for containing therein the injection-solution containers, suitable for obtaining image data of the injection-solution containers having been randomly stored in the storage box, from the top of the storage box, and picking the injection-solution containers one by one in accordance with the thus obtained image data. The first embodiment further provides the system 40 for picking injection-solution containers, including the above-mentioned storage box 10. Furthermore, the container-picking system 40 in accordance with the first embodiment makes it easy to remove wastes such as ampule heads out of the storage box.

### Second Embodiment

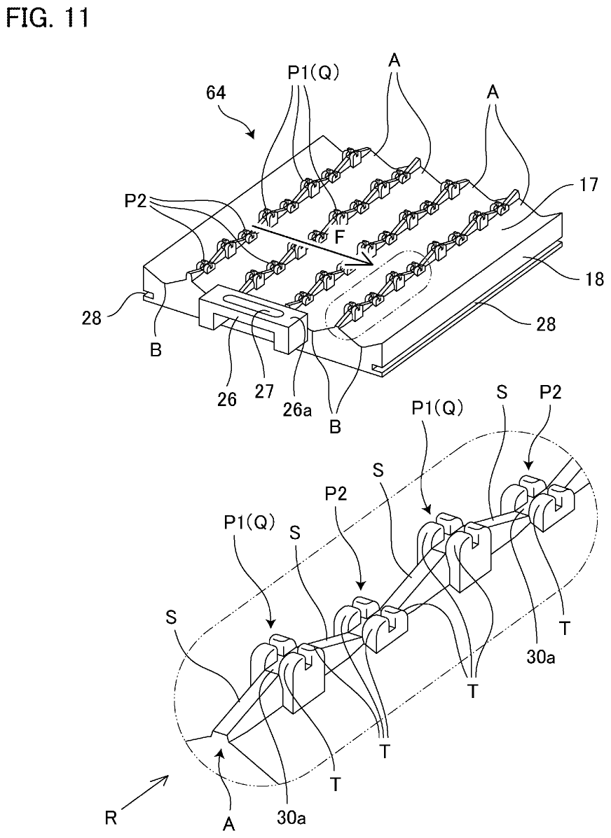

A second embodiment in accordance with the present invention is explained hereinbelow with reference to FIGS. 11 to 13. FIG. 11 includes an enlarged view of a part enclosed with a two-dot chain line.

The second embodiment is different from the first embodiment in a shape of an upper surface of the mounting section provided in the storage box 10. Specifically, the second embodiment is characterized in a geometric feature newly added to the projections and the summits of the mountain parts A in the mounting section 14 identified in the first embodiment.

The first feature of a mounting section 64 of the second embodiment is, as illustrated in FIG. 11, that slope sections S are formed between the taller projections P1 (protrusions Q) and the shorter projections P2 in the mountain parts A.

According to the mounting section 14 of the first embodiment, in an area formed between the taller projections P1 (protrusions Q) and the shorter projections P2 both in the mountain parts A, the summits of the mountain parts A extend substantially horizontally. In contrast, according to the mounting section 64 of the second embodiment as illustrated in FIG. 11, in the same area formed between the taller projections P1 (protrusions Q) and the shorter projections P2, the descending slope sections S having a falling gradient extend from the taller projections P1 (protrusions Q) towards the shorter projections P2 along the summits. The slope sections S make the projections P1 (protrusions Q) have a shape like a mountain when viewed in a direction perpendicular to the predetermined direction.

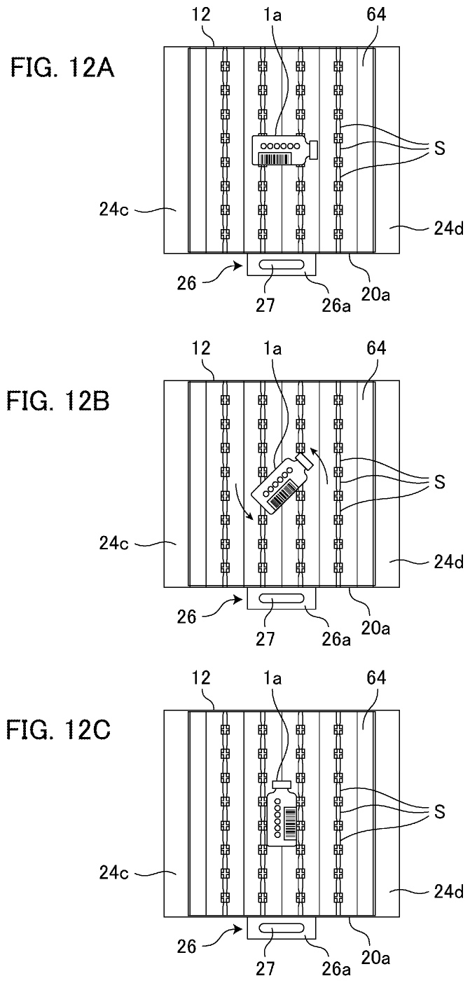

Thus, even if the injection-solution container 1 is laid down in a direction perpendicular to the predetermined direction, as illustrated in FIG. 12A, the slope sections S generate a moment that rotates the injection-solution container 1 when viewed vertically, as illustrated in FIG. 12B. Thus, as illustrated in FIG. 12C, the injection-solution container tends to finally hold still in such a direction that an axis of the injection-solution container extends along the valley parts B of the wavy section. This tendency is enhanced by vibrating the mounting section 64, as mentioned above. Accordingly, the injection-solution container 1 can be taken out by the robot hand 44 such that axis of the injection-solution container 1 having been randomly thrown into the storage box is aligned in a common direction.

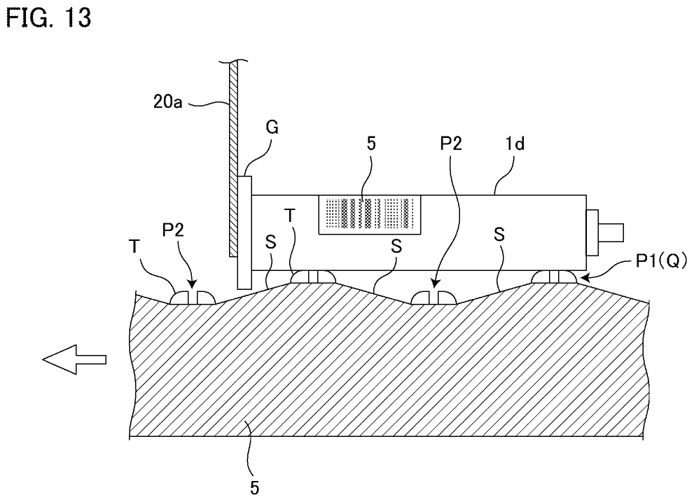

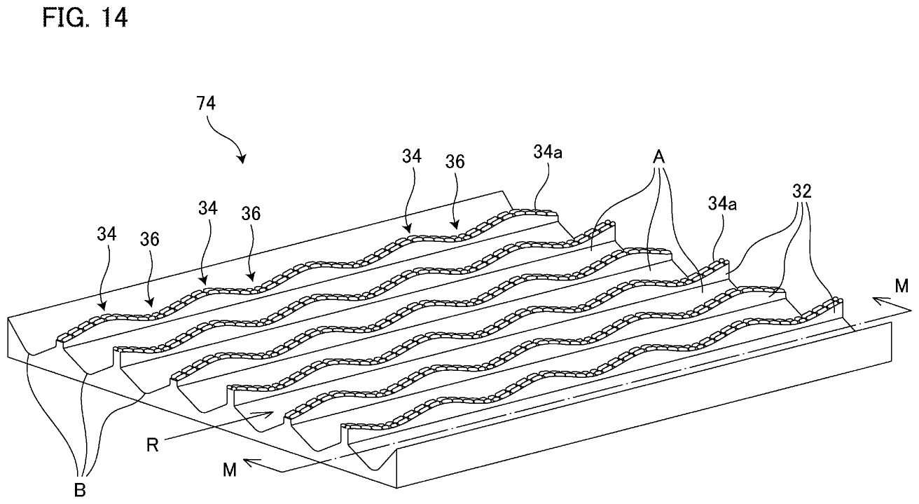

In a case that the injection-solution container 1 is formed at an end thereof with a flange G having a large outer diameter like the syringe 1d illustrated in FIG. 1D, it is afraid that in sliding of the mounting section 64, the flange G is sandwiched between the taller projections P1 and the extending lower ends 21b, and thus the mounting section 64 is difficult to be slid. However, as illustrated in FIG. 13, the flange is upwardly guided by the upslope sections S extending from the shorter projections P2 towards the taller projections P1, and hence, can readily climb over the taller projections P1 in sliding of the mounting section. Therefore it is possible to prevent the flange G from being sandwiched between the taller projections P1 and the front vertical plate 20a, which obviates difficulty in sliding of the mounting section.

The second feature of the mounting section 64 in the second embodiment is that an inclined chamfered portion T is formed at sides of the projections P1 and P2 facing each other along the summits.

Even if the flange G of the injection-solution container 1 is going to be sandwiched between the extending lower ends 21b and sides of the projections P1, P2 in sliding of the mounting section 64, the flange G is upwardly guided by means of the chamfered portion T, and hence, the flange G can readily climb over the projections P1 and P2, ensuring it possible to avoid difficulty in sliding of the mounting section.

FIGS. 11 and 13 illustrate the slope sections S each extending from the taller projection P1 (protrusion Q) along the summit and reaching a bottom of the shorter projection P2. As an alternative, the slope sections S may be designed to terminate in the vicinity of a mid-point between the taller projections P1 and the shorter projections P2.

In the mounting section 64 in the second embodiment, since the projections P1 and P2 are formed at sides thereof with the chamfered portions T, the projections P1 and P2 do not have an upper end comprised of a flat surface. In order to prevent unintended absorption by the suction pad 54, the projections P1 and P2 are each formed at an upper end thereof with a downwardly recessed auxiliary groove 30a.

### Third Embodiment

A third embodiment in accordance with the present invention is explained hereinbelow with reference to FIGS. 14 to 16.

The third embodiment is different from the second embodiment in configuration made on the mountain parts A.

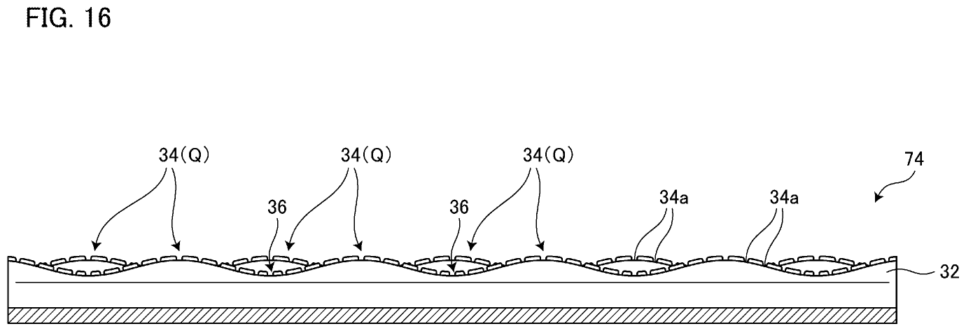

As illustrated in FIGS. 14 to 16, a protrusion in the third embodiment is comprised of a mountain-like geometry 34. Specifically, as illustrated in FIGS. 14 to 16, a plurality of plates 32 stand on an upper surface of a mounting section 74 along the summits of the mountain parts A. Each of the plates 32 has a small width. Each of the plates 32 has an upper edge extending in a sine-curve shape in the predetermined direction, as illustrated in particular in FIG. 16. An upwardly protruding portion of the plate 32 defines the mountain-like geometry 34. Furthermore, the mountain-like geometries 34 situated adjacent to each other are continuous to each other through their skirts. Thus, when viewed in a direction perpendicular to the predetermined direction, a plurality of mountain-like geometries 34 is alternately continuous to each other in the predetermined direction to thereby define a range of mountains.

Phases in arrangement of the mountain-like geometries 34 are designed to be alternate to each other in the predetermined direction between the protrusion rows situated adjacent to each other. Thus, even if an injection-solution container is laid down in a direction perpendicular to the predetermined direction when viewed vertically, the injection-solution container can readily slide down at a body thereof along a skirt of the mountain-like geometry 34, and hence, there is generated a moment which rotates the injection-solution container when viewed vertically. Thus, the injection-solution container tends to finally hold still in a stable posture with an axis thereof being along the valley parts of the wavy section 17. This tendency is further enhanced by applying vibration to the mounting section 64, as mentioned above.

In FIGS. 14 and 16, a reference number 36 indicates a valley-like geometry located between the mountain-like geometries 34 situated adjacent to each other.

Also, the mounting section 74 in the third embodiment is designed to have a simpler geometry on an upper surface thereof than the same in the second embodiment, which permits easier fabrication of a metal mold to be used for making the mounting section 74 in an injection molding process through the use of synthetic resin, and which also permits easier releasing of a product out of a metal mold.

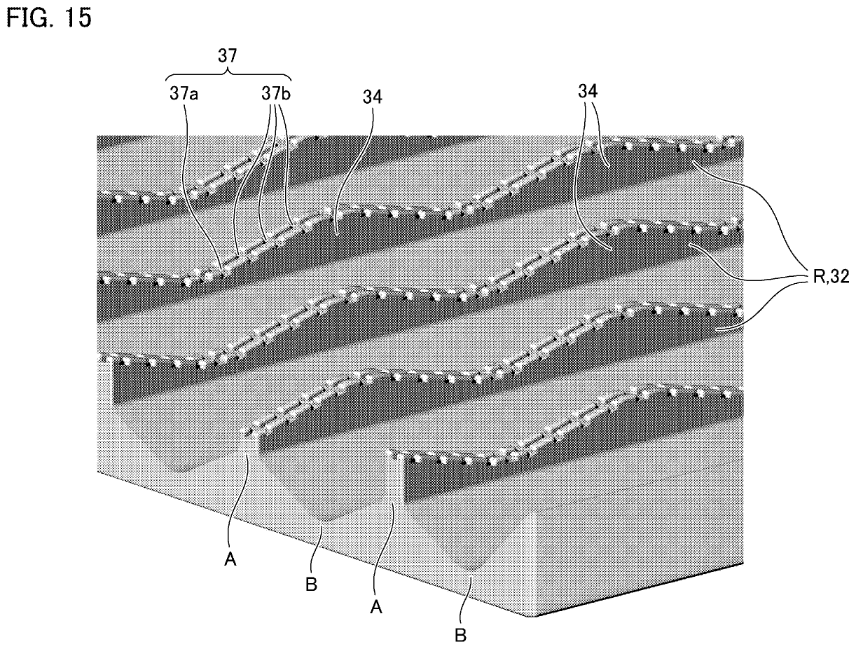

The plate 32 is formed at an upper surface thereof with a downwardly recessed auxiliary groove 37. As illustrated in FIG. 15, the auxiliary groove 37 in the third embodiment is formed at an upper end of the plate 32, and includes a long groove 37a extending in the predetermined direction, and a plurality of lateral grooves 37b each extending perpendicularly to the long groove 37a. The auxiliary groove 37 is used for preventing unintended absorption by the suction pad 54.

Some of the embodiments in accordance with the present invention have been explained so far with reference to the drawings. It should be noted that they are just exemplary, and those skilled in the art can reduce the present invention to practice in other ways with alternatives and/or modification.

### INDUSTRIAL APPLICABILITY

The present invention can be used for solving the problems accompanied with prior art in the field of a storage box for containing therein injection-solution containers, and a system for picking an injection-solution container stored in the storage box.

### INDICATION BY REFERENCE NUMERALS

1, 1a, 1b, 1c, 1d Injection-solution container
10 Storage box for containing therein injection-solution containers
12 Case
13a Upper opening
13b Lower opening (open end)
14, 64, 74 Mounting section
17 Wavy section
21b Extending lower end
30a, 34a Auxiliary groove
34 Mountain-like geometry (Projection P1, Protrusion Q)
40 System for picking an injection-solution container
42 Imaging section
44 Robot hand
46 Image processing section
47 Slider (vibration means)
48 Controller
56 Slide controller
60 Vibrator (vibration means)
A Mountain parts
B Valley parts
P1 Taller projection (Protrusion Q)
P2 Shorter projection
Q Protrusion
R Protrusion rows
S Slope section
T Chamfered portion

1. A storage box for containing therein a columnar hollow injection-solution container, the storage box including:
a case opening at a top end thereof; and
a mounting section provided in the vicinity of a lower end of the case, and designed to mount the injection-solution container thereon,
the mounting section including protrusion rows, each of the protrusion rows including a plurality of protrusions each upwardly extending or expanding from an upper surface of the mounting section in a predetermined direction, phases of the protrusions being alternately arranged in the predetermined direction within the adjacent protrusion rows,
the mounting section further including a wavy section at the upper surface thereof, the wavy section including mountain parts and valley parts alternately positioned in the predetermined direction, the protrusion rows being arranged along summits of the mountain parts,
wherein the injection-solution container thrown in any posture into the case is caused to take a laid-down posture.

2. The storage box as set forth in claim 1, wherein each of the protrusions is shaped to be wavy or mountain-like when viewed in a direction perpendicular to the predetermined direction.

3. The storage box as set forth in claim 1, wherein taller and shorter projections are alternately arranged along the summits, the taller projections defining the protrusions.

4. The storage box as set forth in claim 1, wherein the case is open at a lower end thereof, the mounting section being slidable in the predetermined direction to open and close the open lower end of the case.

5. The storage box as set forth in claim 4, wherein the case includes extending lower ends fittable into the valley parts, the mounting section sliding with the valley parts being almost fit into the extending lower ends.

6. The storage box as set forth in claim 5, further including slope sections extending along the summits, the slope sections each having a falling gradient from each of the taller projections towards each of the shorter projections located adjacent thereto.

7. The storage box as set forth in claim 6, wherein each of the projections facing each other along the summits has an obliquely chamfered portion at a side thereof.

8. The storage box as set forth in claim 1, wherein each of the protrusions is formed at upper ends thereof or each of the summits is partially formed with an auxiliary groove downwardly recessing.

9. The storage box as set forth in claim 2, wherein each of the protrusion row is shaped to be a range of mountains comprising a plurality of mountains positioned in the predetermined direction, when viewed in a direction perpendicular to the predetermined direction.

10. A system for picking a columnar hollow injection-solution container, the system comprising:
a storage box as set forth in claim 1;
an imaging section for taking an image of the injection-solution container having been caused to be in a laid-down posture, from above the storage box;
an image processing section for processing image data taken by the imaging section;
a robot hand picking the injection-solution container one by one; and
a control section for controlling operation of the robot hand.

11. The system as set forth in claim 10, further including vibration means for vibrating the storage box or the mounting section.
